(19) United States
(12) Patent Application Publication
(10) Pub. No.: US 2026/0168593 A1
(43) Pub. Date: Jun. 18, 2026

(54) METHOD FOR CONSTRUCTING IDENTIFICATION MODEL FOR DETECTING VALVE LEAKAGE AND VALVE LEAKAGE SIMULATION SYSTEM

(71) Applicant: METAL INDUSTRIES RESEARCH & DEVELOPMENT CENTRE, Kaohsiung (TW)

(72) Inventors: Ming-Chin CHEN, Kaohsiung (TW); Nai-Chun AN, Kaohsiung (TW)

(21) Appl. No.: 18/985,016

(22) Filed: Dec. 17, 2024

(51) Int. Cl. F16K 37/00; G01M 3/24; G06V 10/774; G06V 10/82

(52) U.S. Cl. CPC F16K 37/0083; G01M 3/24; G06V 10/774; G06V 10/82

(57) ABSTRACT

A method for constructing an identification model for detecting valve leakage and a valve leakage simulation system, and the method includes the following steps: setting up a plurality of valves through the valve leakage simulation system based on piping and valve information; for a plurality of potential leakage scenarios, configuring corresponding leakage flow rates for the plurality of valves to simulate a leakage state of the plurality of valves; deploying a sensing module to collect a plurality of sensor signals from various locations within the valve leakage simulation system over a specific period; and after preprocessing the plurality of sensor signals, generating a plurality of corresponding frequency-domain images, training an attention model through the plurality of frequency-domain images, calculating correlations between frequency values, assigning weights based on the correlations to enhance key features, and ultimately obtaining the identification model through a convolutional neural network.

### BACKGROUND

### Technical Field

The present invention relates to the field of leakage testing, and particularly relates to a method for constructing an identification model for detecting valve leakage and a valve leakage simulation system, aiming at constructing a valve leakage identification model based on actual operation conditions.

### Related Art

In petrochemical, oil refining and other plants, important elements of process pipelines and devices are mostly loaded with flammable, explosive and toxic fluids, however, process pipeline devices at high places often leak or are damaged during operation due to failed effective and full checking because of the inspection difficulty, resulting in unplanned furnace shutdown, industrial safety accidents or casualties.

Long-distance pipeline transportation may cause leakage problems because of old pipelines or pipeline damage, and therefore, it is needed to detect the leakage of pipelines, especially when pipelines are used for transporting flammable gases, the safety is of paramount importance. In order to prevent accidents and ensure safe use, effective leakage detection becomes more important. Existing electrochemical, optical imaging, acoustic detection and other detection methods take a considerable amount of time to test due to the influence of materials, sensor design and data analysis technology factors.

Moreover, previous detection technology cannot cover many and dense production pipelines. Detailed inspection needs a lot of manpower, material resources and time, so production and industrial safety often cannot be taken into account at the same time.

### SUMMARY

The present invention provides a method for constructing an identification model for detecting valve leakage and a valve leakage simulation system, aiming at providing an identification model constructed in an artificial intelligence mode so as to rapidly identify the leakage condition of valves.

The present invention provides a method for constructing an identification model for detecting valve leakage, being applicable to a valve leakage simulation system and comprising the following steps: a piping step: setting up a valve component through the valve leakage simulation system based on piping and valve information; a leakage flow rate simulation step: for a plurality of potential leakage scenarios, configuring corresponding leakage flow rates for the valve component to simulate a leakage state of the valve component; a dataset obtaining step: deploying a sensing module to collect a plurality of sensor signals from various locations within the valve leakage simulation system over a specific period; and a model construction step: after preprocessing the plurality of sensor signals, generating a plurality of corresponding frequency-domain images, training an attention model through the plurality of frequency-domain images, calculating correlations between frequency values, assigning weights based on the correlations to enhance key features, and ultimately obtaining the identification model through a convolutional neural network.

In an embodiment of the present invention, the piping and valve information further comprises a pipeline flow rate, a pipeline pressure, a pipeline length, a pipeline size, a leakage location and a leakage amount.

In an embodiment of the present invention, the sensing module is an acoustic emission sensor.

In an embodiment of the present invention, the plurality of sensor signals is a sound signal.

In an embodiment of the present invention, the model construction step: after preprocessing the plurality of sensor signals, generating a plurality of corresponding frequency-domain images, training an attention model through the plurality of frequency-domain images, calculating correlations between frequency values, assigning weights based on the correlations to enhance key features, and ultimately obtaining the identification model through a convolutional neural network, further comprises: performing the preprocessing through a wavelet transform program; and the calculation formula of the wavelet transform program is:

$${X}_{ω} ( a , b ) = \frac{1}{\sqrt{\vert ( b ) \vert}} {\int }_{- ∞}^{∞} x ( φ ) t ( \frac{t - a}{b} ) d t ,$$

where a refers to a translation position, b refers to a scaling factor, and (φ)t refers to a mother wavelet function.

In an embodiment of the present invention, the model construction step: after preprocessing the plurality of sensor signals, generating a plurality of corresponding frequency-domain images, training an attention model through the plurality of frequency-domain images, calculating correlations between frequency values, assigning weights based on the correlations to enhance key features, and ultimately obtaining the identification model through a convolutional neural network, further comprises: generating time sequence signal energy with a plurality of analysis parameters by using the plurality of sensor signals through the wavelet transform program, respectively obtaining a first time interval and a second time interval according to the plurality of sensor signals, respectively obtaining first signal energy and second signal energy from the time sequence signal energy over the first time interval and the second time interval, and generating a frequency-domain image through the first signal energy and the second signal energy.

The present invention also provides a valve leakage simulation system, being applicable to performing the method for constructing an identification model for detecting valve leakage and comprising: a valve component comprising: a fluid source, a pressure regulating valve, a plurality of shut-off valves, a plurality of throttle valves, a plurality of tee joints, a plurality of steel pipes, a plurality of flowmeters, and a plurality of pressure gauges; a control module in telecommunication connection with the plurality of shut-off valves in the valve component and used for configuring and simulating an internal leakage amount of the plurality of shut-off valves; a sensing module used for collecting a plurality of sensors signals from various locations within the valve component in the valve leakage simulation system over a specific period; and an operation module electrically connected to the control module and the sensing module and used for acquiring the plurality of sensor signals and acquiring an identification model, where the valve component is configured according to piping and valve information.

In an embodiment of the present invention, the plurality of steel pipes is set to be in different lengths according to the piping and valve information, and an open hole can be formed in one of the plurality of steel pipes and used for simulating a pipeline leakage state.

In an embodiment of the present invention, the plurality of tee joints can be connected to the plurality of pressure gauges, and can also be connected to a speed regulating valve and the plurality of flowmeters to simulate a pipeline leakage state.

In an embodiment of the present invention, the control module further comprises a human-computer interface used for configuring and simulating a pipeline flow rate, a pipeline pressure and a leakage amount.

The present invention has the benefits that an operation environment similar to an actual application field is rapidly constructed through the valve leakage simulation system, so that the adaptability stability of a detection system to the actual field environment is improved through the experiment environment with actual operation conditions; and acoustic wave signals generated by various elements are rapidly collected through the acoustic emission sensor and analyzed, thus the environmental influence to be taken into account in leakage detection can be effectively avoided, the time needed for obtaining experiment data and establishing an analysis model is decreased, the identification model can be rapidly and accurately constructed, and the timeframe needed for deploying the detection device is effectively reduced.

### BRIEF DESCRIPTION OF THE DRAWINGS

FIG. 1 is a flowchart of steps of a method for constructing an identification model for detecting valve leakage according to the present invention;

FIG. 2 is a schematic diagram of a frequency-domain image of a method for constructing an identification model for detecting valve leakage according to the present invention;

FIG. 3 is a block diagram of a valve leakage simulation system according to the present invention; and

FIG. 4 is a schematic structural diagram of a valve leakage simulation system according to the present invention.

### DETAILED DESCRIPTION

In order to make the features and advantages of the present invention more obvious and easier to understand, embodiments are described in detail below with reference to the accompanying drawings.

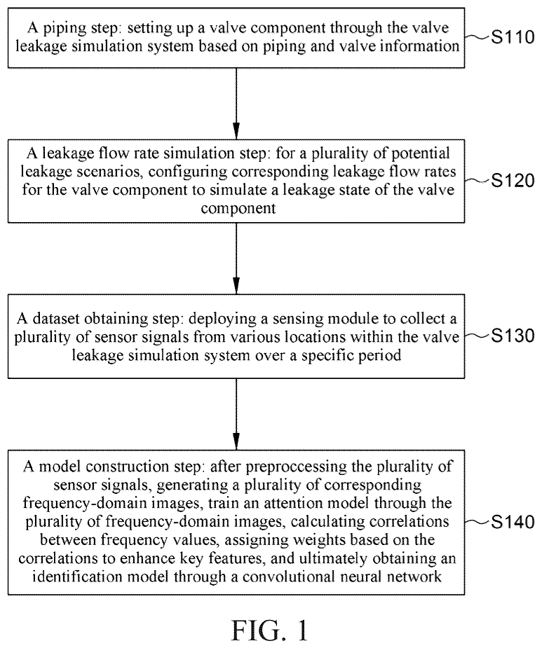

FIG. 1 is a flowchart of steps of a method for constructing an identification model for detecting valve leakage according to the present invention. The method for constructing an identification model for detecting valve leakage is applicable to a valve leakage simulation system and includes the following steps:
S110: a piping step: setting up a valve component through the valve leakage simulation system based on piping and valve information;
S120: a leakage flow rate simulation step: for a plurality of potential leakage scenarios, configuring corresponding leakage flow rates for the valve component to simulate a leakage state of the valve component;
S130: a dataset obtaining step: deploying a sensing module to collect a plurality of sensor signals from various locations within the valve leakage simulation system over a specific period; and
S140: a model construction step: after preprocessing the plurality of sensor signals, generating a plurality of corresponding frequency-domain images, training an attention model through the plurality of frequency-domain images, calculating correlations between frequency values, assigning weights based on the correlations to enhance key features, and ultimately obtaining the identification model through a convolutional neural network.

In the embodiment, the piping and valve information further includes a pipeline flow rate (cm3/h), a pipeline pressure (bar), a pipeline length (cm), a pipeline size (inch), a leakage location and a leakage amount (cm3/h).

The valve component includes: a fluid source, a pressure regulating valve, a plurality of shut-off valves, a plurality of throttle valves, a plurality of tee joints, a plurality of steel pipes, a plurality of flowmeters, and a plurality of pressure gauges.

The plurality of steel pipes is set to be in different lengths according to the piping and valve information, and an open hole can be formed in one of the plurality of steel pipes and used for simulating a pipeline leakage state.

The plurality of tee joints can be connected to the plurality of pressure gauges, and can also be connected to a speed regulating valve and the plurality of flowmeters to simulate a pipeline leakage state.

In the embodiment, the sensing module is an acoustic emission sensor.

In the embodiment, the plurality of sensor signals is a sound signal.

In the embodiment, the preprocessing is performed through a wavelet transform program; and the calculation formula of the wavelet transform program is:

$${X}_{ω} ( a , b ) = \frac{1}{\sqrt{\vert ( b ) \vert}} {\int }_{- ∞}^{∞} x ( φ ) t ( \frac{t - a}{b} ) d t ,$$

where a refers to a translation position, b refers to a scaling factor, and (φ)t refers to a mother wavelet function.

In the embodiment, time sequence signal energy with a plurality of analysis parameters is generated by using the plurality of sensor signals through the wavelet transform program, a first time interval and a second time interval are respectively obtained according to the plurality of sensor signals, first signal energy and second signal energy are respectively obtained from the time sequence signal energy over the first time interval and the second time interval, and a frequency-domain image is generated through the first signal energy and the second signal energy.

In the embodiment, the correlations between the plurality of frequency-domain images and the type of the valve component are calculated, and the higher the correlation is, the higher the weight is.

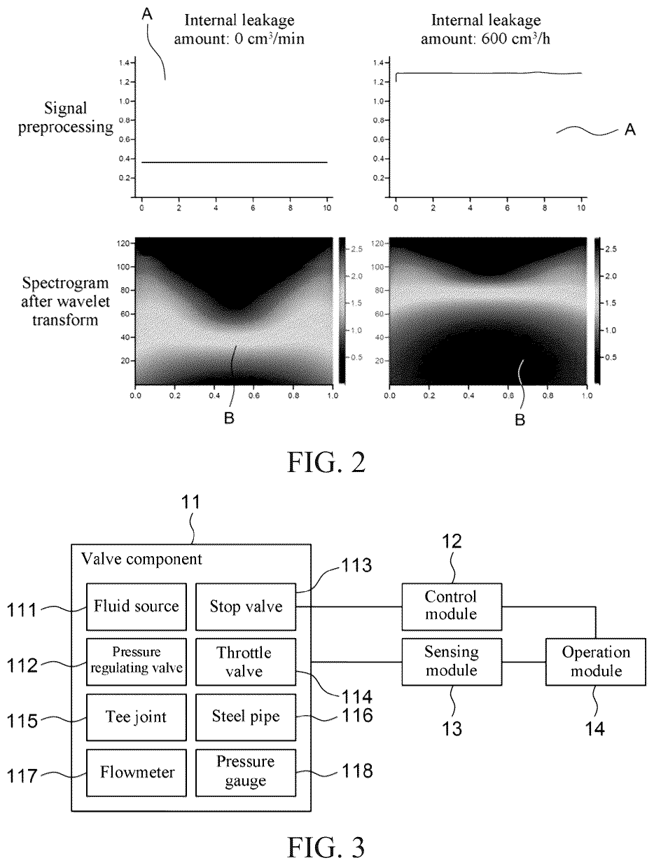

FIG. 2 is a schematic diagram of a frequency-domain image of a method for constructing an identification model for detecting valve leakage according to the present invention. In the embodiment, the construction of an identification model for internal leakage of a shut-off valve is taken as an example, and the plurality of sensor signals A is preprocessed to generate a plurality of corresponding frequency-domain images B, as shown in FIG. 2.

In the embodiment, an attention model is trained through the plurality of frequency-domain images, the correlations between the frequency values are calculated, the weights are assigned based on the correlations to enhance the key features, and then the identification model is ultimately obtained through the convolutional neural network.

In the embodiment, the sensing module is deployed to collect a plurality of sensors signals from various locations within the valve leakage simulation system over a specific period.

The sensing module is an acoustic emission sensor.

The plurality of sensor signals is a sound signal.

In the embodiment, the preprocessing is performed through a wavelet transform program; and the calculation formula of the wavelet transform program is:

$${X}_{ω} ( a , b ) = \frac{1}{\sqrt{\vert ( b ) \vert}} {\int }_{- ∞}^{∞} x ( φ ) t ( \frac{t - a}{b} ) d t ,$$

where a refers to a translation position, b refers to a scaling factor, and (φ)t refers to a mother wavelet function.

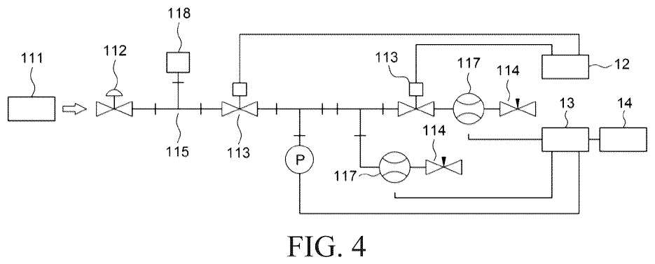

With reference to FIG. 3 and FIG. 4, FIG. 3 is a block diagram of a valve leakage simulation system according to the present invention; and FIG. 4 is a schematic structural diagram of a valve leakage simulation system according to the present invention.

A valve leakage simulation system in the present application is applicable to performing the method for constructing an identification model for detecting valve leakage and includes: a valve component 11 including: a fluid source 111, a pressure regulating valve 112, a plurality of shut-off valves 113, a plurality of throttle valves 114, a plurality of tee joints 115, a plurality of steel pipes 116, a plurality of flowmeters, and a plurality of pressure gauges 118; a control module in telecommunication connection with the plurality of shut-off valves 113 in the valve component 11 and used for configuring and simulating an internal leakage amount of the plurality of shut-off valves 113; a sensing module 13 used for collecting a plurality of sensor signals from various locations within the valve component 11 in the valve leakage simulation system over a specific period; and an operation module 14 electrically connected to the control module and the sensing module 13 and used for acquiring the plurality of sensor signals and acquiring an identification model, where the valve component 11 is configured according to piping and valve information.

In the embodiment, the plurality of steel pipes 116 is set to be in different lengths according to the piping and valve information, and an open hole can be formed in one of the plurality of steel pipes 116 and used for simulating a pipeline leakage state.

In the embodiment, the plurality of tee joints 115 can be connected to the plurality of pressure gauges 118, and can also be connected to a speed regulating valve and the plurality of flowmeters to simulate a pipeline leakage state.

In the embodiment, the installation positions of the plurality of shut-off valves 113 can be adjusted to simulate a pipeline leakage state.

In the embodiment, the control module further includes a human-computer interface used for configuring and simulating a pipeline flow rate, a pipeline pressure and a leakage amount.

In the embodiment, the valve leakage simulation system further includes a pressurization auxiliary device used for adjusting the pipeline flow rate and the pipeline pressure.

In conclusion, an operation environment similar to an actual application field is rapidly constructed through the valve leakage simulation system according to the present invention, so that the adaptability stability of a detection system to the actual field environment is improved through the experiment environment with actual operation conditions; and acoustic wave signals generated by various elements are rapidly collected through the acoustic emission sensor and analyzed, thus the environmental influence to be taken into account in leakage detection can be effectively avoided, the time needed for obtaining experiment data and establishing an analysis model is decreased, the identification model can be rapidly and accurately constructed, and the timeframe needed for deploying the detection device is effectively reduced.

The present invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for constructing an identification model for detecting valve leakage, being applicable to a valve leakage simulation system and comprising the following steps:
a piping step: setting up a valve component through the valve leakage simulation system based on piping and valve information;
a leakage flow rate simulation step: for a plurality of potential leakage scenarios, configuring corresponding leakage flow rates for the valve component to simulate a leakage state of the valve component;
a dataset obtaining step: deploying a sensing module to collect a plurality of sensor signals from various locations within the valve leakage simulation system over a specific period; and
a model construction step: after preprocessing the plurality of sensor signals, generating a plurality of corresponding frequency-domain images, training an attention model through the plurality of frequency-domain images, calculating correlations between frequency values, assigning weights based on the correlations to enhance key features, and ultimately obtaining the identification model through a convolutional neural network.

2. The method for constructing an identification model for detecting valve leakage according to claim 1, wherein the piping and valve information further comprises a pipeline flow rate, a pipeline pressure, a pipeline length, a pipeline size, a leakage location and a leakage amount.

3. The method for constructing an identification model for detecting valve leakage according to claim 1, wherein the sensing module is an acoustic emission sensor.

4. The method for constructing an identification model for detecting valve leakage according to claim 3, wherein the plurality of sensor signals is a sound signal.

5. The method for constructing an identification model for detecting valve leakage according to claim 1, wherein the model construction step: after preprocessing the plurality of sensor signals, generating a plurality of corresponding frequency-domain images, training an attention model through the plurality of frequency-domain images, calculating correlations between frequency values, assigning weights based on the correlations to enhance key features, and ultimately obtaining the identification model through a convolutional neural network, further comprises: performing the preprocessing through a wavelet transform program; and the calculation formula of the wavelet transform program is:
$${X}_{ω} ( a , b ) = \frac{1}{\sqrt{\vert ( b ) \vert}} {\int }_{- ∞}^{∞} x ( φ ) t ( \frac{t - a}{b} ) d t ,$$
wherein a refers to a translation position, b refers to a scaling factor, and (φ)t refers to a mother wavelet function.

6. The method for constructing an identification model for detecting valve leakage according to claim 5, wherein the model construction step: after preprocessing the plurality of sensor signals, generating a plurality of corresponding frequency-domain images, training an attention model through the plurality of frequency-domain images, calculating correlations between frequency values, assigning weights based on the correlations to enhance key features, and ultimately obtaining the identification model through a convolutional neural network, further comprises: generating time sequence signal energy with a plurality of analysis parameters by using the plurality of sensor signals through the wavelet transform program, respectively obtaining a first time interval and a second time interval according to the plurality of sensor signals, respectively obtaining first signal energy and second signal energy from the time sequence signal energy over the first time interval and the second time interval, and generating a frequency-domain image through the first signal energy and the second signal energy.

7. A valve leakage simulation system, being applicable to performing the method for constructing an identification model for detecting valve leakage that incorporates a piping step of setting up a valve component through the valve leakage simulation system based on piping and valve information; a leakage flow rate simulation step of, for a plurality of potential leakage scenarios, configuring corresponding leakage flow rates for the valve component to simulate a leakage state of the valve component; a dataset obtaining step of deploying a sensing module to collect a plurality of sensor signals from various locations within the valve leakage simulation system over a specific period; and a model construction step of, after preprocessing the plurality of sensor signals, generating a plurality of corresponding frequency-domain images, training an attention model through the plurality of frequency-domain images, calculating correlations between frequency values, assigning weights based on the correlations to enhance key features, and ultimately obtaining the identification model through a convolutional neural network, the system comprising:
a valve component comprising:
a fluid source;
a pressure regulating valve;
a plurality of shut-off valves;
a plurality of throttle valves;
a plurality of tee joints;
a plurality of steel pipes;
a plurality of flowmeters;
a plurality of pressure gauges;
a control module being in telecommunication connection with the plurality of shut-off valves in the valve component and used for configuring and simulating an internal leakage amount of the plurality of shut-off valves;
a sensing module used for collecting a plurality of sensor signals from various locations within the valve component in the valve leakage simulation system over a specific period; and
an operation module electrically connected to the control module and the sensing module and used for acquiring the plurality of sensor signals and acquiring an identification model,
wherein the valve component is configured according to piping and valve information.

8. The valve leakage simulation system according to claim 7, wherein the plurality of steel pipes is set to be in different lengths according to the piping and valve information, and an open hole can be formed in one of the plurality of steel pipes and used for simulating a pipeline leakage state.

9. The valve leakage simulation system according to claim 7, wherein the plurality of tee joints can be connected to the plurality of pressure gauges, and can also be connected to a speed regulating valve and the plurality of flowmeters to simulate a pipeline leakage state.

10. The valve leakage simulation system according to claim 7, wherein the control module further comprises a human-computer interface used for configuring and simulating a pipeline flow rate, a pipeline pressure and a leakage amount.
